(19) United States
(12) Patent Application Publication
(10) Pub. No.: US 2025/0088935 A1
(43) Pub. Date: Mar. 13, 2025

(54) CELL RESELECTION POLICY METHOD, SYSTEM, DEVICE, AND COMPUTER-READABLE MEDIUM

(71) Applicant: RAKUTEN SYMPHONY, INC., Tokyo (JP)

(72) Inventor: Subramanya CHANDRASHEKAR, Indore (IN)

(21) Appl. No.: 18/248,243

(22) PCT Filed: Jan. 11, 2023
(86) PCT No.: PCT/US2023/010584

§ 371 Date: Apr. 7, 2023

(51) Int. Cl. H04W 36/38; H04W 36/00

(52) U.S. Cl. CPC H04W 36/385; H04W 36/008375

(57) ABSTRACT

A user equipment (UE) includes a memory having non-transitory instructions stored therein, and a processor coupled to the memory, and being configured to execute the instructions, thereby causing the UE to receive a cell reselection policy from a network, the cell reselection policy including a cell reselection criterion based on mobility history information (MHI) of a plurality of UEs other than the UE. While camped on a first cell and operating in an idle mode, the UE receives a first reference signal from the first cell and a second reference signal from a second cell, and applies the cell reselection policy to the first and second reference signals, thereby determining whether to remain camped on the first cell. Based on the determination, the UE either remains camped on the first cell or performs a cell reselection to the second cell.

### TECHNICAL FIELD

This description relates to a method, system, device, and non-transitory computer-readable medium directed to automated generation and execution of cell reselection policies in telecommunication applications.

### BACKGROUND

Telecommunication, e.g., cellular, systems include increasing numbers of cells having overlapping coverage areas and increasing varieties of sizes and signal strengths. A user equipment (UE) operating in an idle mode is often considered to be “camped” on a given cell based on an initial confirmation that the cell meets certain predefined suitability criteria. Once camped on a first cell, the UE has access to and from a radio access network (RAN) but is not actively connected to the RAN until it switches from the idle mode into a connected mode. A UE in idle mode moving among overlapping cells is presented with the option of remaining camped on the first cell or temporarily switching to the connected mode to reselect a second cell on which to camp.

### SUMMARY

In some embodiments, a UE includes a memory having non-transitory instructions stored therein, and a processor coupled to the memory, and being configured to execute the instructions, thereby causing the UE to receive a cell reselection policy from a network, wherein the cell reselection policy includes a cell reselection criterion based on mobility history information (MHI) of a plurality of UEs other than the UE, and, while camped on a first cell and operating in an idle mode, receive a first reference signal from the first cell and a second reference signal from a second cell and apply the cell reselection policy to the first and second reference signals, thereby determining whether to remain camped on the first cell. Based on the determination, the UE either remains camped on the first cell or performs a cell reselection to the second cell.

In some embodiments, an apparatus includes a memory having non-transitory instructions stored therein, and a processor coupled to the memory, and being configured to execute the instructions, thereby causing the apparatus to receive MHI from each UE of a plurality of first UEs, generate a cell reselection policy including a cell reselection criterion based on the received MHI, and transmit the cell reselection policy to a second UE.

In some embodiments, a method includes using a network device to receive MHI from each UE of a plurality of first UEs, apply a machine learning algorithm to the received MHI to generate an idle mode cell reselection policy including a cell reselection criterion based on the received MHI, and transmit the idle mode cell reselection policy to a second UE, and using the second UE to receive the idle mode cell reselection policy, receive first and second reference signals from respective first and second cells while in an idle mode, and based on applying the idle mode cell reselection policy to the first and second reference signals, either remain in the idle mode camped on the first cell or switch out of the idle mode and perform a cell reselection so as to camp on the second cell.

### BRIEF DESCRIPTION OF DRAWINGS

Aspects of the present disclosure are best understood from the following detailed description when read with the accompanying figures. In accordance with the standard practice in the industry, various features are not drawn to scale. In fact, the dimensions of the various features are arbitrarily increased or reduced for clarity of discussion.

FIGS. 1A-IC are diagrams of a communication system, in accordance with some embodiments.

FIG. 2 is a flowchart of a cell reselection policy generation method, in accordance with some embodiments.

FIGS. 3A and 3B are flowcharts of a cell reselection policy generation method, in accordance with some embodiments.

FIG. 4 is a diagram of a processor-based device, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows include embodiments in which the first and second features are formed or positioned in direct contact and include embodiments in which additional features are formed or positioned between the first and second features, such that the first and second features are in indirect contact. In addition, the present disclosure repeats reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of a system or object in use or operation in addition to the orientation depicted in the figures. The system is otherwise oriented (rotated 90 degrees or at other orientations) and the spatially relative descriptors used herein likewise are interpreted accordingly.

In various embodiments, some or all of a method, system, device, and computer readable medium are directed to using a network device to receive mobility history information (MHI) from multiple user equipment (UE) sources, generate a cell reselection policy including one or more cell reselection criteria based on the MHI, e.g., by applying a machine learning (ML) algorithm, and transmit the cell reselection policy to a UE. The UE receives the cell reselection policy, may use self-generated data to fine-tune the policy, and receives reference signals from first and second cells, and based on applying the cell reselection policy to the reference signals, either remains camped on the first cell or performs a reselection to the second cell. In some embodiments, the UE sources generate, and the network device receives, the MHI including cell reselection activity information in addition to industry standard-based MHI, e.g., information corresponding to technical specification 3GPP TS 38.305.

By using one or both of a UE or a network device to execute some or all of the operations of the present disclosure, idle mode cell reselection policies in a telecommunication system are based on UE activity such that cell reselection is more efficient than in telecommunication systems in which reselection policies are not based on UE activity, e.g., based solely on predetermined criteria. Because each cell reselection requires a UE to temporarily transition out of idle mode to a higher power connected mode, and includes UE-cell communications, the improved reselection efficiency serves to reduce UE power requirements, thereby extending battery life, and reduces radio resource usage both in the UE and in the telecommunication system overall compared to other approaches.

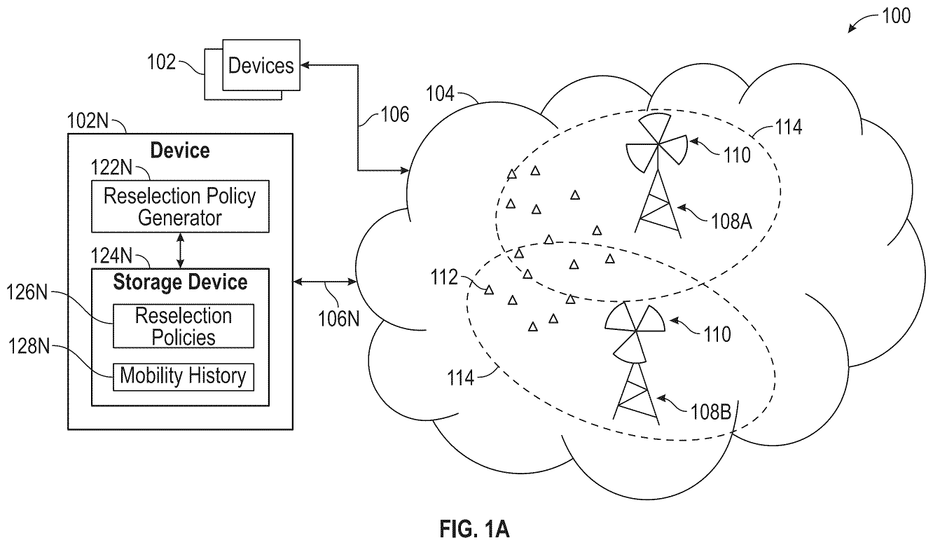

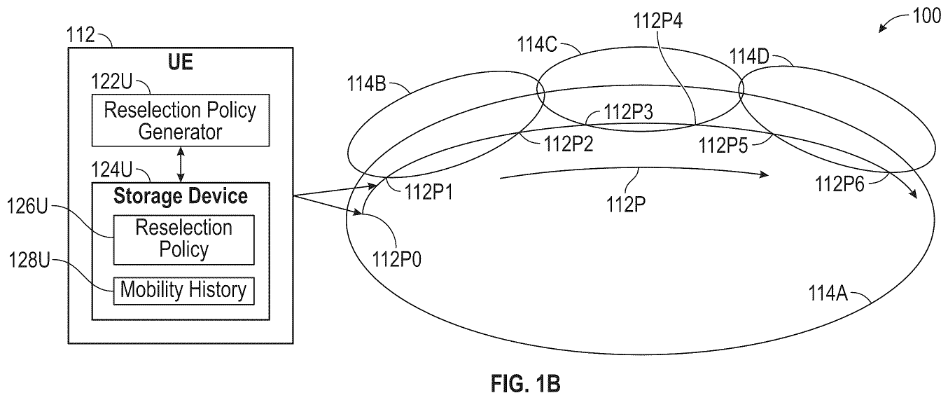

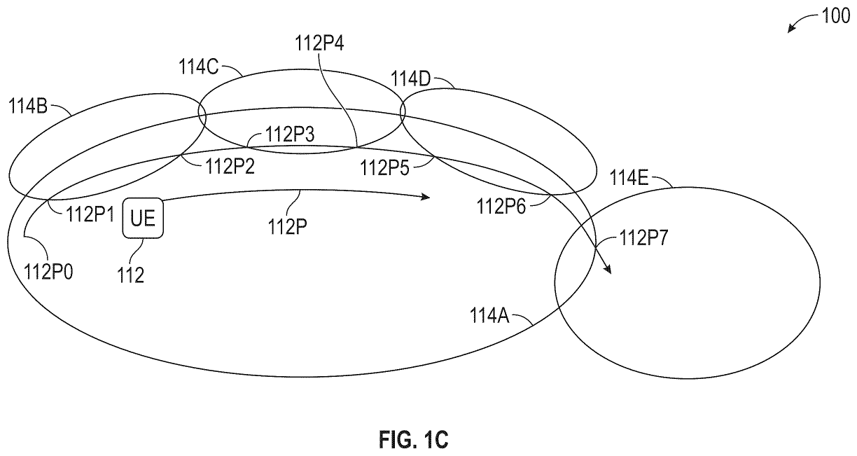

FIGS. 1A-1C are diagrams of a telecommunication system 100 (hereinafter referred to as “system 100”), in accordance with some embodiments. Each of FIGS. 1A-1C is simplified for the purpose of illustration.

System 100 includes devices 102 coupled to a network 104 by links 106. Network 104 is coupled to a device 102N of devices 102 by a link 106N of links 106. Devices 102 including device 102N are coupled to each other through network 104 and links 106 including link 106N.

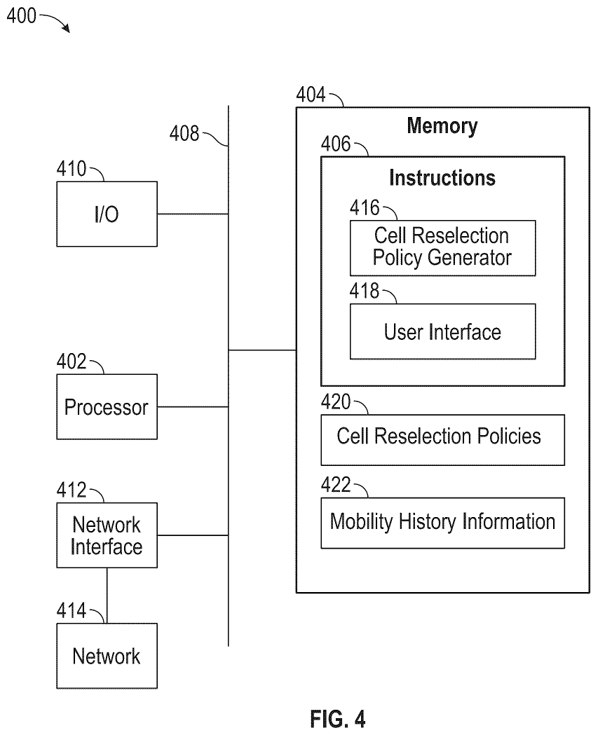

In various embodiments, devices 102 correspond to combinations of computing devices, computing systems, servers, server clusters, and/or pluralities of server clusters also referred to as server farms or data centers in some embodiments. In some embodiments, a device 400 discussed below with respect to FIG. 4 is an embodiment of a device 102.

In some embodiments, one or more of devices 102 is a type of mobile terminal, fixed terminal, or portable terminal including a desktop computer, laptop computer, notebook computer, netbook computer, tablet computer, wearable circuitry, mobile handset, server, gaming console, stationary or moving sensor, or combination thereof. In some embodiments, one or more of devices 102 includes a display by which a user interface is displayed. Other configurations and/or types of devices 102 are within the scope of the present disclosure.

In the embodiment depicted in FIG. 1A, device 102N includes a cell reselection policy generator 122N and a storage device 124N configured to store one or more cell reselection policies 126N and mobility history 128N. In some embodiments, cell reselection policy generator 122N is also referred to as reselection policy generator 122N, cell reselection policies 126N are also referred to as reselection policies 126N, and/or mobility history 128N is also referred to as mobility history information (MHI) 128N and/or enhanced MHI 128N.

In the embodiment depicted in FIG. 1A, device 102N including reselection policy generator 122N is a single instance of plurality of devices 102. In some embodiments, device 102N including reselection policy generator 122N includes more than one instance of plurality of devices 102. Each of reselection policy generator 122N, reselection policies 126N, and mobility history 128N is further discussed below.

A storage device, e.g., storage device 124N, is one or more computer-readable, non-volatile storage devices, e.g., a database. In some embodiments, a storage device includes a memory 404 discussed below with respect to FIG. 4. In the embodiment depicted in FIG. 1A, storage device 124N is located on device 102N. In some embodiments, storage device 124N is located externally to device 102N, e.g., on one or more servers accessed via link 106N.

In the embodiment depicted in FIG. 1A, a single instance of storage device 124N is configured to store reselection policies 126N and mobility history 128N. In some embodiments, storage device 124N includes more than one instance, e.g., distributed on multiple servers, each instance configured to store some or all of each of cell reselection policies 126N and mobility history 128N.

Network 104 is one or more interconnected devices (not depicted individually) configured to provide electronic communications between and among the interconnected devices and plurality of devices 102, in some cases through plurality of links 106. In some embodiments, network 104 corresponds to the internet.

In some embodiments, network 104 includes or represents a radio-access network (RAN), a mobile telecommunication system that implements a radio access technology (RAT) and resides between devices such as mobile phones, computers, or other devices and provides connection with plurality of devices 102.

In some embodiments, one or more of the interconnected devices of network 104 and/or plurality of devices 102 are configured as one or more of a local area network (LAN), a wide area network (WAN), a metropolitan area network (MAN), an internet area network (IAN), a campus area network (CAN), or a virtual private network (VPN). In some embodiments, one or more of the interconnected devices of network 104 and/or plurality of devices 102 are configured as a backbone or core network (CN), a part of a computer network that interconnects networks, providing a path for the exchange of information between different LANs, WANs, etc.

In some embodiments, some of the interconnected devices of network 104 and/or devices 102 are configured as server clusters, e.g., included in a data center. In some embodiments, the server clusters are part of a cloud computing environment.

In the embodiment depicted in FIG. 1A, network 104 includes base stations 108A and 108B (hereinafter base station 108), each including an antenna 110 wirelessly connected to one or more instances of user equipment (UE) 112 located in a geographic coverage area 114.

In some embodiments, network 104 is a global system for mobile communications (GSM) RAN, a GSM/EDGE RAN, a universal mobile telecommunications system (UMTS) RAN (UTRAN), an evolved universal terrestrial radio access network (E-UTRAN, open RAN (O-RAN), or cloud-RAN (C-RAN). In some embodiments, network 104 resides between a UE 112 (e.g., mobile phone, a computer, or any remotely controlled machine) and one or more core networks.

In some embodiments, network 104 is a hierarchical telecommunications network including one or more intermediate link(s), also referred to as backhaul portions in some embodiments, between a RAN and one or more core networks. Two common methods of mobile backhaul implementations are fiber-based backhaul and wireless point-to-point backhaul. Other methods, such as copper-based wireline, satellite communications and point-to-multipoint wireless technologies are being phased out as capacity and latency requirements become higher in 4G and 5G networks. Backhaul generally refers to the side of the network that communicates with the global internet. UEs 112 communicating with a base station 108 constitute a local subnetwork. In some embodiments, a backhaul includes wired, fiber optic, and/or wireless components including microwave bands and mesh and edge network topologies that use a high-capacity wireless channel to get packets to the microwave or fiber links.

In some embodiments, base stations 108 are lattice or self-supported towers, guyed towers, monopole towers, and concealed towers (e.g., towers designed to resemble trees, cacti, water towers, signs, light standards, and other types of structures). In some embodiments, a base station 108 is a cellular-enabled mobile device site where antennas and electronic communications equipment are placed, typically on a radio mast, tower, or other raised structure to create a cell (or adjacent cells) in a network. The raised structure typically supports antenna(s) 110 and one or more sets of transmitter/receivers, transceivers, digital signal processors, control electronics, a remote radio head (RRH), primary and backup electrical power sources, and sheltering. Base stations are known by other names such as base transceiver station, mobile phone mast, or cell tower. In some embodiments, base stations are edge devices configured to wirelessly communicate with UEs. The edge device provides an entry point into service provider core networks. Examples include routers, routing switches, integrated access devices (IADs), multiplexers, and a variety of MAN and WAN access devices.

In at least one embodiment, an instance of antenna 110 is a sector antenna, e.g., a directional microwave antenna with a sector-shaped radiation pattern, or a plurality of sector antennae, e.g., configured to have a full-circle coverage area 114. In some embodiments, an instance of antenna 110 is a circular antenna. In some embodiments, an instance of antenna 110 operates at microwave or ultra-high frequency (UHF) frequencies (300 Megahertz (MHz) to 3 Gigahertz (GHz)).

In various embodiments, a geographic coverage area 114, also referred to as a cell 114 in some embodiments, is a three-dimensional space having a shape and size based on the configurations of the corresponding base station 108, e.g., a power level, and antenna 110, e.g., a number of sectors. In various embodiments, a geographic coverage area 114 has a substantially spherical, hemispherical, conical, columnar, circular or oval disc, or other shape corresponding to a base station and antenna configuration. In various embodiments, one or both of the shape or size of a geographic coverage area 114 varies over time, e.g., based on a variable base station power level and/or a variable number of activated antennae and/or antenna sectors.

In some embodiments, a geographic coverage area 114 is referred to as a macro-cell, a micro-cell, a pico-cell, a femto-cell, or a small cell. In some embodiments, a coverage area 114 is referred to as an indoor small cell (IDSC).

Some or all instances of base station 108 are configured to transmit reference signals including at least one primary synchronization signal (PSS), at least one secondary synchronization signal (SSS), and additional physical channel signals. The physical channel signals include master information blocks (MIBs) and system information blocks (SIBs) that together include cell identifiers, tracking area codes, cell availability indicators (e.g., suitable, acceptable, reserved., barred, available to closed subscriber group only), service level indicators, time and/or frequency resource allocation indicators, and other information relevant to cell-based communications.

In some embodiments, an instance of UE 112 is a computer or computing system. In some embodiments, an instance of UE 112 has a liquid crystal display (LCD), light-emitting diode (LED) or organic light-emitting diode (OLED) screen interface, such as a graphical user interface providing a touchscreen interface with digital buttons and keyboard or physical buttons along with a physical keyboard. In some embodiments, an instance of UE 112 connects to the internet and interconnects with other devices. In some embodiments, an instance of UE 112 incorporates integrated cameras, the ability to place and receive voice and video telephone calls, video games, and Global Positioning System (GPS) capabilities. In some embodiments, an instance of UE 112 performs as a virtual machine or allows third-party apps to run as a container. In some embodiments, an instance of UE 112 is a computer (such as a tablet computer, netbook, digital media player, digital assistant, graphing calculator, handheld game console, handheld personal computer (PC), laptop, mobile internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card.

A UE 112 is configured to receive the reference signals transmitted by a first instance of base station 108, decode and validate relevant information contained therein, and based on validating the decoded information, camp on the coverage area 114 corresponding to the first instance of base station 108. Once camped on the corresponding coverage area 114, the UE 112 is configured to operate in an idle mode in which the UE has access to and from a RAN but is not actively connected and does not have a dedicated connection to the RAN until it switches from idle mode into a connected mode.

As depicted in FIG. 1A, some instances of coverage areas 114 overlap such that a given UE 112 is capable of being positioned in multiple instances of coverage area 114 simultaneously. A UE 112 operating in idle mode and camped on a first instance of the overlapping coverage areas 114, referred to as a first cell 114 in some embodiments, is thereby presented with a choice of remaining camped on the first cell 114 or temporarily switching to connected mode and reselecting a second instance of coverage area 114, referred to as a second cell 114 in some embodiments, on which to camp.

A given instance of UE 112, as depicted in FIG. 1B, is further configured to include a cell reselection policy generator 122U and a storage device 124U configured to store a cell reselection policy 126U and mobility history information (MHI) 128U. In some embodiments, cell reselection policy generator 122U is also referred to as reselection policy generator 122U, cell reselection policy 126U is also referred to as reselection policy 126U, and/or mobility history 128U is also referred to as MHI 128U and/or enhanced MHI 128U. Each of cell reselection policy generator 122U, cell reselection policy 126U, and mobility history information 128U is further discussed below.

In some embodiments, a given instance of UE 112 does not include reselection policy generator 122U. In some embodiments, a given instance of UE 112 corresponds to device 400 discussed below with respect to FIG. 4.

In some embodiments, a user of network 104, e.g., a user of a device 102, accesses network 104 through a service provider, a business or organization that sells bandwidth or network access by providing direct internet backbone access to internet service providers and usually access to its network access points (NAPs). Service providers are sometimes referred to as backbone providers or internet providers. Service providers consist of telecommunications companies, data carriers, wireless communications providers, internet service providers, and cable television operators offering high-speed internet access.

Links 106 include hardware configured to enable electronic communications between devices 102 and network 104. In various embodiments, one or more of links 106 is a wired link, e.g., fiber optic, shielded, twisted pair, or other cabling, or a wireless link type.

In various embodiments, one or more of links 106 is configured to communicate based on code division multiple access (CDMA), wideband CDMA (WCDMA), time division multiple access (TDMA), frequency division multiple access (FDMA), Orthogonal Frequency Division Multiplexing (OFDM), time division duplexing (TDD), frequency division duplexing (FDD), Bluetooth, Infrared (IR), or the like, or other protocols that may be used in a wired or wireless data communications network. Accordingly, the exemplary illustrations provided herein are not intended to limit the embodiments of the disclosure and are merely to aid in the description of aspects of the embodiments of the disclosure.

Reselection policy generator 122N is one or more sets of instructions configured to be executed on device 102N whereby reselection policies 126N are generated, structured, modified, stored in storage device 124N, and transmitted to one or more UEs 112 in accordance with a cell reselection policy generation method 200 discussed below. In some embodiments, reselection policy generator 122N is configured to run as a standalone program or within one or more sets of instructions. In some embodiments, reselection policy generator 122N is configured to run one or more of devices 102 in addition to device 102A.

Reselection policy generator 122N is configured to receive instances of MHI 128U from each UE 112 of a plurality of UEs 112, store some or all of the instances of received MHI 128U as mobility history 128N in storage device 124N, access mobility history 128N from storage device 124N, generate and modify reselection policies 126N based on mobility history 128N, and transmit at least one reselection policy 126N to at least one UE 112 of the plurality of UEs 112 or to at least one UE 112 separate from the plurality of UEs 112.

In some embodiments, one or more sets of instructions separate from reselection policy generator 122N are configured to receive and store the instances of mobility history 128U from the plurality of UEs 112, and reselection policy generator 122N is configured to access mobility history 128N from storage device 124N based on mobility history 128N having been previously stored by the separate instructions.

Mobility histories 128U and 128N include data records of information corresponding to multiple aspects of UE 112 operational activities, including at least information in accordance with one or more industry standards corresponding to UE-base station communications, e.g., technical specification 3GPP TS 38.305. In some embodiments, mobility histories 128U and 128N include data records of information in addition to that corresponding to one or more industry standards.

In some embodiments, mobility history 128U and 128N include data records of one or more of UE positioning, speed, direction, trajectory, and/or altitude; locations, times, dates, signal frequencies and power levels, and other details of cell reselection activities; reselection decision results; discovered cell radio conditions during reselection; UE idle/connected mode timing, duration, and switching frequency history; visited cell history information including cell identifiers and/or other MIB and/or SIB details; intra-frequency and/or inter-frequency operational information, e.g., signal frequencies, bandwidths, priority levels, or the like; performance statistics of a cell reselection policy; or other information related to UE cell reselection activities.

In various embodiments, device 102N is configured to receive mobility histories 128U from multiple instances of UE 112 including a uniform set of data records or varying sets of data records and/or having uniform or varying data record formats. In various embodiments, reselection policy generator 122N is configured to store mobility history 128N in storage device 124N including a same set of data records or varying sets of data records and/or having uniform or differing data record formats as those of some or all of received mobility histories 128U.

In various embodiments, multiple instances of UE 112 are configured to transmit mobility histories 128U to one or more instances of device 102N including a uniform set of data records or varying sets of data records and/or having uniform or varying data record formats. In various embodiments, a given UE 112 is configured to transmit corresponding instances of mobility history 128U over time having a uniform set of data records or varying sets of data records and/or having uniform or varying data record formats.

In some embodiments, UEs 112 are configured to transmit MHI 128U to one or more instances of device 102N when operating in connected mode. In some embodiments, a given UE 112 is configured to, e.g., periodically and/or after a predetermined time period, switch out of idle mode into connected mode, transmit MHI 128U to one or more instances of device 102N, then switch back to idle mode. In some embodiments, a given UE 112 is configured to transmit MHI 128U to one or more instances of device 102N after otherwise switching from idle mode to connected mode, e.g., in response to user activity or as part of performing a cell reselection to a neighboring cell.

In some embodiments, reselection policy generator 122N is configured to include information in mobility history 128N in addition to MHI 128U received from UEs 112, e.g., event and/or measurement information corresponding to connected mode activities of UEs 112 that are received and/or transmitted by device 102N and/or other instances of devices 102.

Reselection policy generator 122N is configured to generate and/or modify reselection policies 126N based on subsets of MHI 128N retrieved from storage device 124N. In various embodiments, reselection policy generator 122N is configured to retrieve a given subset including data records corresponding to MHI 128U received from multiple instances of UE 112, e.g., multiple instances of UE 112 positioned in a same geographic area and having similar trajectories and/or mobility directions, and/or multiple instances of UE 112 selected based on hardware and/or software configuration criteria.

In some embodiments, reselection policy generator 122N includes one or more algorithms configured to generate and/or modify reselection policies 126N based on mobility history 128N. In some embodiments, the one or more algorithms based on mobility history 128N are configured to generate and/or modify a given reselection policy 126N structured to reduce a number of cell reselections compared to a default cell reselection policy based on predetermined criteria, e.g., based solely on relative priority or power levels of a first cell reference signal and one or more other cell reference signals.

In some embodiments, reselection policy generator 122N includes one or more artificial intelligence (AI), e.g., machine learning (ML), algorithms configured to generate and/or modify reselection policies 126N by using MHI 128N as training and/or feedback input. In some embodiments, reselection policy generator 122N is configured to use MHI 128N as training and/or feedback input by selecting one or more subsets of MHI 128N configured to match a corresponding ML algorithm. In some embodiments, one or more ML algorithms include a neural network algorithm, e.g., a convolutional neural network algorithm.

Reselection policy generator 122N is configured to generate reselection policies 126N including data records of reselection criteria (e.g., signal power or quality level thresholds or ranges, or cell types, sizes, or priority levels) and decision indicators (e.g., select/skip indicators or priority level assignations).

In some embodiments, reselection policy generator 122N is configured to generate and/or modify a variety of reselection policies 126N, a given reselection policy variation corresponding to one or more features of UEs 112, e.g., a power saving algorithm having one of a variety of complexity levels ranging from basic to advanced. In some embodiments, reselection policy generator 122N is configured to generate and/or modify a given reselection policy variation corresponding to one or more hardware and/or software versions of UEs 112, e.g., a manufacturer and/or model number, or operating system type and/or update level.

Reselection policy generator 122N is configured to transmit generated and/or modified reselection policies 126N to UEs 112, e.g., periodically or responsive to one or more triggering activities of one or both of device 102N or UE 112. In some embodiments, reselection policy generator 122N is configured to transmit specific variations of generated and/or modified reselection policies 126N to UEs 112 based on the one or more features and/or hardware and/or software versions of the corresponding UEs 112. Reselection policy generator 122N may also transmit one or more indicators configured to facilitate using the generated and/or modified reselection policies 126N to UEs 112, e.g., one or more UE-specific parameters that a given UE 112 may use to run additional algorithms and/or perform fine-tuning adjustments to the reselection policies 126N.

A given UE 112 is configured to receive the corresponding generated or modified reselection policy 126N and store it in storage device 124U as reselection policy 126U. In some embodiments, a given UE 112 includes reselection policy generator 122U configured to modify the received reselection policy 126N (e.g., by changing a threshold level based on mobility history 128U) prior to storing it in storage device 124U as reselection policy 126U.

Reselection policy 126U includes data records usable by UE 112 as part of an idle mode operation in which UE 112 determines whether to remain camped on a first cell 114 or perform a reselection to a second cell 114 based on reselection policy 126U.

Reselection policy generator 122U is one or more sets of instructions configured to be executed on UE 112 whereby reselection policies 126N are received, modified in some embodiments, and stored in storage device 124U as reselection policy 126U. In some embodiments, reselection policy generator 122U is configured to modify reselection policy 126U, e.g., periodically, based on MHI 128U. In some embodiments, the one or more sets of instructions include one or more AI, e.g., ML, algorithms configured to modify reselection policy 126U by using MHI 128U as training and/or feedback inputs. In some embodiments, reselection policy generator 122U is configured to run as a standalone program or within one or more sets of instructions.

UE 112 including reselection policy generator 122U is configured to apply reselection policy 126U to idle mode cell reselection activities in accordance with cell reselection policy generation method 200 discussed below. In some embodiments, UE 112 does not include reselection policy 126U, and UE 112 is configured to apply reselection policy 126U to idle mode cell reselection activities in accordance with cell reselection policy generation method 200 including storing received reselection policy 126N in storage device 124U as reselection policy 126U without modification.

Each of FIGS. 1B and 1C depicts a non-limiting example of an instance of UE 112 applying reselection policy 126U in idle mode operation. Each of FIGS. 1B and 1C depicts UE 112 (further simplified for clarity in FIG. 1C) and coverage areas 114A-114D, also referred to as cells 114A-114D in some embodiments. FIG. 1C further includes a coverage area 114E, also referred to as cell 114E in some embodiments. As depicted in FIGS. 1B and 1C, each of cells 114B-114E overlaps cell 114A. In some embodiments, cell 114A is referred to as first cell 114A and one or more of cells 114B-114E is referred to as a second cell 114B-114E.

The non-limiting example depicted in FIG. 1B corresponds to either an intra-frequency case in which each of cells 114A-114D operates on a same frequency having a same priority level, e.g., a priority level assigned by a network manager, or an inter-frequency case in which cells 114B-114D operate on multiple frequencies having a same priority level. The non-limiting example depicted in FIG. 1C corresponds to an inter-frequency case in which cell 114A operates on a first frequency and each of cells 114B-114E operates on one or more second frequencies, each having a lower priority level than that of the first frequency.

In the non-limiting examples depicted in FIGS. 1B and 1C, reference signals of each of cells 114B-114E have higher power levels than a power level of a cell 114A reference signal.

The depiction of boundaries of cells 114A-114E in FIGS. 1B and 1C is simplified for the purpose of illustration. In some embodiments, a boundary of a cell 114A-114E corresponds to locations at which the reference signal of the cell 114A-114E has a power level equal to a power level threshold above which UE 112 is considered to be within the cell 114A-114E. In some embodiments, a boundary of a cell 114A-114E corresponds to predefined coordinates, e.g., stored in a storage device and/or received by UE 112 from device 102N. In some embodiments, a boundary of a cell 114A-114E corresponds to locations based on another suitable criterion or a combination of criteria.

Each of FIGS. 1B and 1C also depicts a path 112P within cell 114A along which UE 112 travels in idle mode in the direction of the arrows, e.g., as transported by a user of UE 112. A position 112P0 corresponds to a first point along path 112P, positions 112P1 and 112P2 correspond to points at which path 112P intersects with the boundary of cell 114B, positions 112P3 and 112P4 correspond to points at which path 112P intersects with the boundary of cell 114C, and positions 112P5 and 112P6 correspond to points at which path 112P intersects with the boundary of cell 114D.

At position 112P0, UE 112 is camped on cell 114A based on receiving the cell 114A reference signal. At position 112P1, UE 112 enters an area of overlap between cells 114A and 114B and receives reference signals from each of cells 114A and 114B until reaching position 112P2 and receiving only the cell 114A reference signal. At position 112P3, UE 112 enters an area of overlap between cells 114A and 114C and receives reference signals from each of cells 114A and 114C until reaching position 112P4 and receiving only the cell 114A reference signal. At position 112P5, UE 112 enters an area of overlap between cells 114A and 114D and receives reference signals from each of cells 114A and 114D until reaching position 112P6 and receiving only the cell 114A reference signal.

After reaching position 112P1, UE 112 applies cell reselection policy 126U to determine whether to remain camped on cell 114A or perform a reselection to cell 114B. After reaching position 112P2, depending on the prior determination, UE 112 either continues to remain camped on cell 114A or performs a reselection to cell 114A from cell 114B.

After reaching position 112P3, UE 112 applies cell reselection policy 126U to determine whether to remain camped on cell 114A or perform a reselection to cell 114C. After reaching position 112P4, depending on the prior determination, UE 112 either continues to remain camped on cell 114A or performs a reselection to cell 114A from cell 114C.

After reaching position 112P5, UE 112 applies cell reselection policy 126U to determine whether to remain camped on cell 114A or perform a reselection to cell 114D. After reaching position 112P6, depending on the prior determination, UE 112 either continues to remain camped on cell 114A or performs a reselection to cell 114A from cell 114D.

A UE, e.g., UE 112, travelling along path 112P thereby performs zero, two, four, or six cell reselections based on applying a cell reselection policy, e.g., cell reselection policy 126U, after reaching each of positions 112P1, 112P3, and 112P5.

In the example depicted in FIG. 1B in which reference signals of each of cells 114A-114D have a same priority level, a UE travelling along path 112P and applying a cell reselection policy other than cell reselection policy 126U, e.g., based solely on predetermined criteria including reference signal strength, could perform a total of six reselections based on cell 114B-114D reference signals having higher power levels than the cell 114A reference signal.

UE 112 travelling along path 112P instead applies cell reselection policy 126U based on cell reselection policy 126N received from device 102N and generated based on mobility history 128N. By including at least one cell reselection criterion based on mobility history 128N, e.g., including UE 112 switching frequency data, cell reselection policy 126U has flexibility and is thereby capable of being applied whereby UE 112 performs fewer than six reselections, thereby saving power and reducing radio resource usage compared to other approaches.

In some embodiments, the at least one cell reselection criterion of cell reselection policy 126U is based on MHI 128N including one or more of cell size information, reference signal quality information, collective cell switching and trajectory histories of UEs 112, time of day, day of the week, or other suitable parameters obtained from UEs 112.

In the inter-frequency example depicted in FIG. 1C in which cell 114A is operating in one frequency and the rest of the cells 114B/C/D and E are operating in another frequency, a UE 112 travelling along path 112P and applying a cell reselection policy other than cell reselection policy 126U, e.g., based solely on predetermined criteria including reference signal frequency priority levels, could perform zero reselections based on cell 114B-114E reference signal frequency having a lower priority level than that of the cell 114A reference signal frequency.

UE 112 travelling along path 112P instead applies cell reselection policy 126U having flexibility by being based on MHI 128N, e.g., including cell 114B-114D signal quality data, and thereby being capable of being applied whereby UE 112 performs two, four, or six reselections in which UE 112 connection quality is improved compared to other approaches. In this particular example, the UE 112 is capable of being selectively guided using the cell reselection policy 126U to not consider cells 114B, 114C, and 114D for reselection, while performing cell reselection to 114E.

In some embodiments, UE 112 includes cell reselection policy generator 122U configured to generate or modify the at least one cell reselection criterion of cell reselection policy 126U based on MHI 128U, e.g., the specific cell switching and trajectory history of the instance of UE 112, whereby cell reselection policy 126U flexibility is capable of being further improved compared to embodiments in which an instance of UE 112 does not include cell reselection policy generator 122U.

below depicts a non-limiting example of a reselection policy
126N and/or 126U.

| Speed Range | Neighbor Cell Signal Power | Reselection Decision |
|---|---|---|
| (kmph) | Level (dBm) | Indicator |
| S1-S2 (High) | X1 (Low) | Skip |
| S1-S2 (High) | Y1 (Medium) | Skip |
| S3-S4 (Medium) | X1 (Low) | Skip |
| S3-S4 (Medium) | Y1 (Medium) | Skip |

### Table 1—Reselection Policy Example

In the non-limiting example depicted in Table 1, reselection policy 126N and/or 126U includes data records including reselection criteria corresponding to a UE 112 speed range (in kilometers per hour) and a second (neighbor) cell, e.g., cell 114 or 114-B-114D, reference signal power level (in decibels referenced to one milliwatt), and corresponding reselection indicators.

As depicted in Table 1, a High speed range is defined by speed thresholds S1 and S2, a Medium speed range is defined by speed thresholds S3 and S4, and Low and Medium signal power levels are defined by respective power thresholds X1 and Y1. Because the example reselection policy 126N and/or 126U includes a decision indicator of Skip for each of the four depicted combinations, a UE 112 applying the example reselection policy as reselection policy 126U would skip performing a reselection to the second cell in each of the four situations, thereby remaining camped on a first cell, e.g., cell 114 or 114A.

In the non-limiting example depicted in Table 1, at least one of thresholds S1-S4, X1, or Y1, or indicator Skip is based on MHI 128N, e.g., as generated or modified by reselection policy generator 122N. In some embodiments, reselection policy generator 122N is configured to generate and/or modify multiple instances of reselection policy 126N, and the at least one of thresholds S1-S4, X1, or Y1, or indicator Skip of the depicted reselection policy 126N and/or 126U is one of multiple corresponding thresholds or indicators of the multiple instances of reselection policy 126N.

In some embodiments, Table 1 depicts a reselection policy 126U in which reselection policy generator 122U has modified, based on MHI 128U, at least one of thresholds S1-S4, X1, or Y1, or indicator Skip in a reselection policy 126U previously received from device 102N.

TABLE 2
below depicts a non-limiting example of a mobility
history 128U and/or 128N.

| | | | | Neighbor | |
|---|---|---|---|---|---|
| | First | | Neighbor | Cell | Reselected |
| Time | Cell ID | UE Location | Cell ID | Parameters | Cell ID |
| 8:00 | 114A | 112P0 | 114B | 114B: PL, SQ | n/a |
| | | (X0, Y0) | | | |
| 8:05 | 114A | 112P1 | 114B | 114B: PL, SQ | 114B |
| | | (X1, Y1) | | | |
| 8:15 | 114B | 112P2 | 114A, | 114A: PL, SQ | n/a |
| | | (X2, Y2) | 114C | 114C: PL, SQ | |
| 8:25 | 114A | 112P3 | 114C | 114C: PL, SQ | 114C |
| | | (X3, Y3) | | | |

### Table 2—Mobility History Example

In the non-limiting example depicted in Table 2, MHI 126U and/or 126U includes data records corresponding to UE 112 travelling along path 112P depicted in FIGS. 1B and 1C and including a time, a first cell ID, a UE location, a second (neighbor) cell ID, second cell signal parameters including a signal power level SP and a signal quality measurement SQ, and a reselected cell ID.

At a first time (8:00), UE 112 is located at position 112P0 having coordinates X0, Y0, is within and camped on cell 114A, and is sufficiently close to cell 114B such that the corresponding data record includes cell 114B ID and measured values of parameters PL and SQ for cell 114B. Because position 112P0 is located outside of cell 114B, UE 112 does not apply a reselection policy and remains camped on cell 114A.

At a second time (8:05), UE 112 is located at position 112P1 having coordinates X1,Y1, is within and initially camped on cell 114A, and is within cell 114B such that the corresponding data record includes cell 114B ID and measured values of parameters PL and SQ for cell 114B. Because position 112P1 is located within each of cells 114A and 114B, UE 112 applies reselection policy 126U and, based on determining to reselect cell 112B, performs a reselection to cell 114B so as to camp on cell 114B.

At a third time (8:15), UE 112 is located at position 112P2 having coordinates X2, Y2, is outside of and initially camped on cell 114B, is within cell 114A such that the corresponding data record includes cell 114A ID and measured values of parameters PL and SQ for cell 114A, and is sufficiently close to cell 114C such that the corresponding data record includes cell 114C ID and measured values of parameters PL and SQ for cell 114C. Because position 112P2 is located outside of cell 114B and within cell 114A, UE 112 applies reselection policy 126U and, based on determining to reselect cell 112A, performs a reselection to cell 114A so as to camp on cell 114A.

At a fourth time (8:25), UE 112 is located at position 112P3 having coordinates X3, Y3, is within and initially camped on cell 114A, and is within cell 114C such that the corresponding data record includes cell 114C ID and measured values of parameters PL and SQ for cell 114C. Because position 112P3 is located within each of cells 114A and 114C, UE 112 applies reselection policy 126U and, based on determining to reselect cell 112C, performs a reselection to cell 114C so as to camp on cell 114C.

The non-limiting examples depicted in Tables 1 and 2 are simplified for the purpose of illustration. In various embodiments, given instances of reselection policies 126N and/or 126U and/or mobility histories 128U and/or 128N include numbers of data records and amount of data greater than the numbers and data amounts depicted in Tables 1 and 2.

The scenarios and data record configurations of system 100 discussed above with respect to FIGS. 1B and 1C and Tables 1 and 2 are non-limiting examples provided for the purpose of illustration. Embodiments of system 100 including other scenarios and/or data record configurations are within the scope of the present disclosure.

System 100 including device 102N and/or UE 112 configured as discussed above is thereby configured to perform some or all of using reselection policy generator 122N of device 102N to receive mobility history 128U from multiple UEs 112, generate cell reselection policies 126N including one or more cell reselection criteria based on mobility history 128N, e.g., by applying a ML algorithm, and transmit a cell reselection policy 126U to UE 112, and/or using UE 112 to receive cell reselection policy 126N, receive reference signals from first and second cells 114, based on applying cell reselection policy 126U to the reference signals, either remain camped on the first cell 114 or perform a reselection to the second cell 114, and in some embodiments, perform predetermined transmission operations in which mobility history 128U including cell reselection activity information is transmitted to device 102N.

Idle mode cell reselection policies in system 100 are thereby based on UE 112 activity such that cell reselection is more efficient than in telecommunication systems in which reselection policies are not based on UE activity, e.g., based solely on predetermined criteria. Because each cell reselection requires a UE to temporarily transition out of idle mode to a higher power connected mode, and includes UE-cell communications, the improved reselection efficiency serves to reduce UE power requirements, thereby extending battery life, and reduces radio resource usage both in the UE and in the telecommunication system overall compared to other approaches.

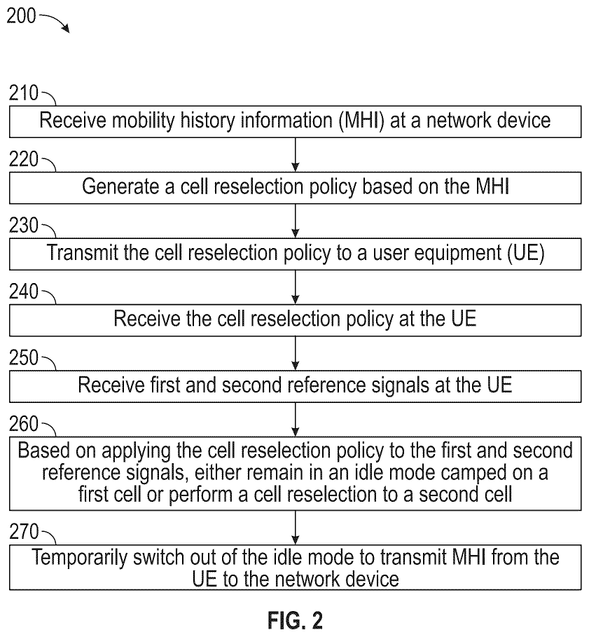

FIG. 2 is a flowchart of cell reselection policy generation method 200, in accordance with some embodiments. Cell reselection policy generation method 200, also referred to as method 200 in some embodiments, is operable on a telecommunication system, e.g., telecommunication system 100 discussed above with respect to FIGS. 1A-1C.

Additional operations may be performed before, during, between, and/or after the operations of method 200 depicted in FIG. 2, and some other operations may only be briefly described herein. In some embodiments, other orders of operations of method 200 are within the scope of the present disclosure. In some embodiments, one or more operations of method 200 are not performed. In some embodiments, the operations of method 200 are included in another method, e.g., a method of operating a telecommunication system.

In some embodiments, some or all of the operations of method 200 discussed below are capable of being performed automatically, e.g., by network device 102N including reselection policy generator 122N, UE 112, and/or reselection policy generator 122U, each discussed above with respect to FIGS. 1A-1C and/or by using processing circuitry 402 discussed below with respect to FIG. 4.

The operations of method 200 are discussed below with reference to various features of system 100 that are also discussed above respect to FIGS. 1A-1C.

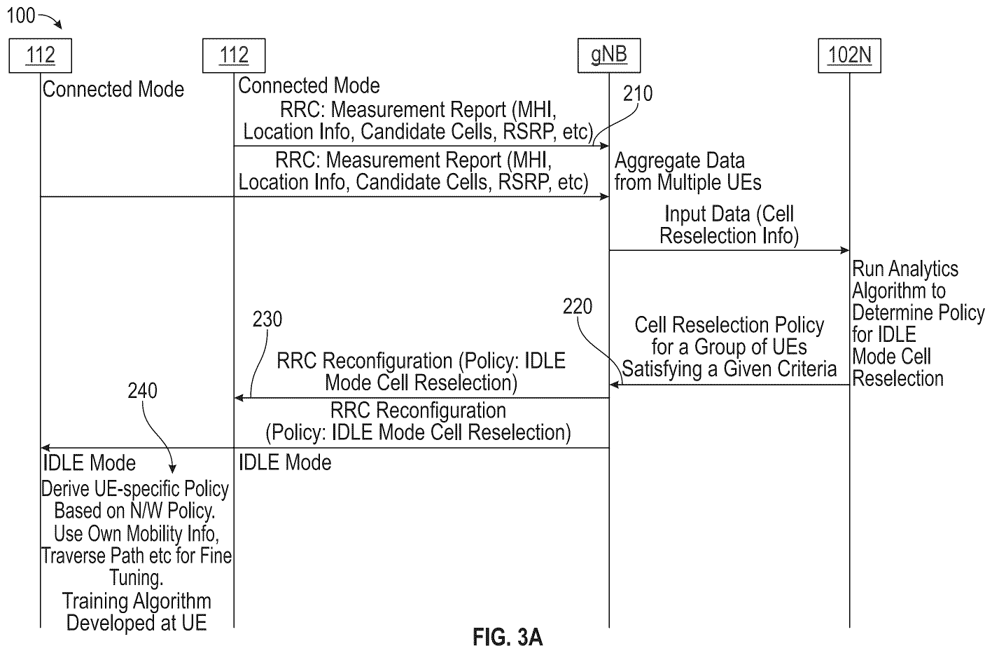

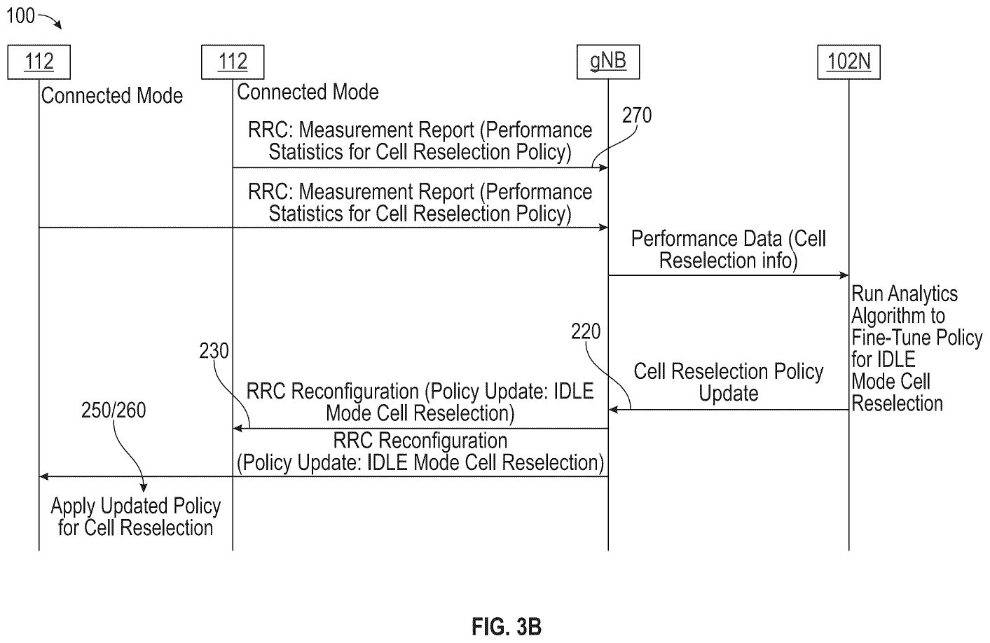

FIGS. 3A and 3B depict a non-limiting example that illustrates the execution of some or all of the operations of method 200 using an embodiment of system 100 including two instance of UE 112 a 5G radio node gNB, and device 102N.

At operation 210, in some embodiments, MHI is received at a network device. Receiving the MHI at the network device includes receiving mobility history 128U at device 102N as discussed above. In the non-limiting example depicted in FIGS. 3A and 3B, receiving the MHI includes using node gNB to receive MHI from multiple UEs 112, aggregate the received MHI, and transmit the aggregated MHI to device 102N.

At operation 220, in some embodiments, a cell reselection policy is generated based on the MHI. Generating the cell reselection policy includes using reselection policy generator 122N to generate and/or modify reselection policies 126N, e.g., based on a ML algorithm, as discussed above. In some embodiments, including the non-limiting example depicted in FIGS. 3A and 3B, generating the cell reselection policy includes generating and/or modifying the cell reselection policy based on each of receiving the MHI in each of operations 210 and 270.

At operation 230, in some embodiments, the cell reselection policy is transmitted to a UE. Transmitting the cell reselection policy to the UE includes using reselection policy generator 122U to transmit reselection policy 126N to one or more UEs 112 as discussed above. In the non-limiting example depicted in FIGS. 3A and 3B, transmitting the cell reselection policy to the UE includes using node gNB to transmit reselection policy 126N.

At operation 240, in some embodiments, the cell reselection policy is received at the UE. Receiving the cell reselection policy at the UE includes using one or more instances of UE 112 to receive one or more reselection policies 126N from device 102N as discussed above. In the non-limiting example depicted in FIGS. 3A and 3B, receiving the cell reselection policy at the UE includes using two instances of UE 112 to receive reselection policies 126N from node gNB.

In some embodiments, receiving the cell reselection policy at the UE includes using reselection policy generator 122U of UE 112 to modify reselection policy 126U, e.g., based on a ML algorithm, thereby generating or modifying reselection policy 126U as discussed above.

At operation 250, in some embodiments, first and second signals are received at the UE. Receiving the first and second signals includes receiving first and second cell 114 signals at UE 112 as discussed above.

At operation 260, in some embodiments, based on applying the cell reselection policy to the first and second reference signals, the UE either remains in an idle mode camped on a first cell or performs a cell reselection to a second cell. The UE either remaining camped on the first cell or performing the cell reselection to the second cell based on applying the cell reselection policy to the first and second reference signals includes UE 112 either remaining camped on the first cell 114 or performing the cell reselection to the second cell 114 based on applying cell reselection policy 126U as discussed above.

At operation 270, in some embodiments, the UE temporarily switches out of idle mode to transmit MHI to the network device. The UE temporarily switching of idle mode to transmit MHI to the network device includes UE 112 switching from idle mode to connected mode, transmitting mobility history 1128U to device 102N, then switching from connected mode to idle mode. In the non-limiting example depicted in FIGS. 3A and 3B, transmitting the MHI to device 102N includes using node gNB to receive MHI from multiple UEs 112 and transmit the received MHI to device 102N.

By performing some or all of the operations of method 200, a system, e.g., system 100, automatically generates and/or modifies flexible cell reselection policies applied in idle mode UE reselection determinations whereby the benefits discussed above with respect to system 100 are capable of being realized.

FIG. 4 is a functional block diagram of a computer or processor-based device 400 upon which or by which an embodiment is implemented.

Processor-based device 400 is programmed to facilitate automated generation and/or modification of cell reselection policies, as described herein, and includes, for example, bus 408, processing circuitry 402, also referred to a processor 402 in some embodiments, and memory 404 components.

In some embodiments, processor-based device 400 includes a communication mechanism such as bus 408 for transferring information and/or instructions among the components of processor-based device 400. Processing circuitry 402 is connected to bus 408 to obtain instructions for execution and process information stored in, for example, memory 404. In some embodiments, processing circuitry 402 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of processing circuitry 402. Similarly, an ASIC is configurable to perform specialized functions not easily performed by a more general-purpose processor. Other specialized components to aid in performing the functions described herein optionally include one or more field programmable gate arrays (FPGA), one or more controllers, or one or more other special-purpose computer chips.

In one or more embodiments, processing circuitry (or multiple processors) 402 performs a set of operations on information as specified by a set of instructions stored in memory 404 related to cell reselection policies, e.g., a cell reselection policy generator 416 corresponding to reselection policy generator 122N or 122U discussed above with respect to FIGS. 1A-3B. The execution of the instructions causes the processor to perform specified functions.

Processing circuitry 402 and accompanying components are connected to memory 404 via bus 408. Memory 404 includes one or more of dynamic memory (e.g., RAM, magnetic disk, writable optical disk, or the like) and static memory (e.g., ROM, CD-ROM, or the like) for storing executable instructions that when executed perform the operations described herein to facilitate automated network configuration. In some embodiments, memory 404 also stores the data associated with or generated by the execution of the operations, e.g., cell reselection policies 420 which corresponds to reselection policies 126N or reselection policy 126U, and mobility history information 422 which corresponds to mobility history 128U or 128N, each discussed above with respect to FIGS. 1A-3B.

In one or more embodiments, memory 404, such as a random-access memory (RAM) or any other dynamic storage device, stores information including processor instructions for facilitating network application implementation. Dynamic memory allows information stored therein to be changed. RAM allows a unit of information stored at a location called a memory address to be stored and retrieved independently of information at neighboring addresses. Memory 404 is also used by processing circuitry 402 to store temporary values during execution of processor instructions. In various embodiments, memory 404 includes a read only memory (ROM) or any other static storage device coupled to bus 408 for storing static information, including instructions, that is not capable of being changed by processing circuitry 402. Some memory is composed of volatile storage that loses the information stored thereon when power is lost. In some embodiments, memory 404 includes a non-volatile (persistent) storage device, such as a magnetic disk, optical disk, or flash card, for storing information, including instructions, that persists even when device 400 is turned off or otherwise loses power.

The term “computer-readable medium” as used herein refers to any medium that participates in providing information to processing circuitry 402, including instructions 406 for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer reads. The term computer-readable storage medium is used herein to refer to a computer-readable medium.

Instructions 406 also include a user interface 418, one or more sets of instructions configured to allow effective operation and control of device 400 by a user. In some embodiments, user interface 418 is configured to operate though one or more layers, including a human-machine interface (HMI) that interfaces machines with physical input hardware such as keyboards, mice, or game pads, and output hardware such as computer monitors, speakers, printers, and other suitable user interfaces.

In some embodiments, a UE includes a memory having non-transitory instructions stored therein, and a processor coupled to the memory, and being configured to execute the instructions, thereby causing the UE to receive a cell reselection policy from a network, wherein the cell reselection policy includes a cell reselection criterion based on MHI of a plurality of UEs other than the UE, and, while camped on a first cell and operating in an idle mode, receive a first reference signal from the first cell and a second reference signal from a second cell and apply the cell reselection policy to the first and second reference signals, thereby determining whether to remain camped on the first cell. Based on the determination, the UE either remains camped on the first cell or performs a cell reselection to the second cell. In some embodiments, the cell reselection criterion includes a reference signal power threshold level, and the instructions are executable by the processor to cause the UE to determine whether to remain camped on the first cell based on a comparison of the second reference signal to the reference signal power threshold level. In some embodiments, the instructions are executable by the processor to cause the UE to further apply the cell reselection policy by using a machine learning algorithm to modify the cell reselection policy received from the network, and using the modified cell reselection policy to determine whether to remain camped on the first cell. In some embodiments, the instructions are executable by the processor to cause the UE to modify the cell reselection policy by applying the machine learning algorithm to MHI of the UE. In some embodiments, the instructions are executable by the processor to cause the UE to determine whether to remain camped on the first cell based on the first and second reference signals being intra-frequency signals. In some embodiments, the instructions are executable by the processor to cause the UE to determine whether to remain camped on the first cell based on the first and second reference signals being inter-frequency signals. In some embodiments, the instructions are executable by the processor to further cause the UE to transmit MHI to the network, wherein the MHI includes UE locations of cell reselection occurrences, discovered cell radio conditions, UE speed, and UE mode and visited cell history information, and/or performance statistics of the cell reselection policy. In some embodiments, the instructions are executable by the processor to further cause the UE to, while remaining camped in the first cell, transmit the MHI by switching from operating in the idle mode to operating in a connected mode, while operating in the connected mode, transmitting the MHI to the network, and after transmitting the MHI, returning to operating in the idle mode. In some embodiments, the cell reselection policy is based on a capability of the UE.

In some embodiments, an apparatus includes a memory having non-transitory instructions stored therein, and a processor coupled to the memory, and being configured to execute the instructions, thereby causing the apparatus to receive MHI from each UE of a plurality of first UEs, generate a cell reselection policy including a cell reselection criterion based on the received MHI, and transmit the cell reselection policy to a second UE. In some embodiments, the instructions are executable by the processor to cause the apparatus to generate the cell reselection policy by applying a machine learning algorithm to the received MHI. In some embodiments, the instructions are executable by the processor to cause the apparatus to receive the MHI including cell reselection policy performance statistics. In some embodiments, the instructions are executable by the processor to further cause the apparatus to modify the cell reselection policy based on the MHI comprising the cell reselection policy performance statistics, and transmit the modified cell reselection policy to the second UE. In some embodiments, the instructions are executable by the processor to cause the apparatus to generate the cell reselection policy further based on a capability of the second UE. In some embodiments, the instructions are executable by the processor to cause the apparatus to generate the cell reselection criterion based on one or both of intra-frequency reference signals or inter-frequency reference signals. In some embodiments, the instructions are executable by the processor to cause the apparatus to generate the cell reselection criterion including a reference signal power threshold level based on the received MHI. In some embodiments, the apparatus includes a radio node of a telecommunications network.

In some embodiments, a method includes using a network device to receive MHI from each UE of a plurality of first UEs, apply a first machine learning algorithm to the received MHI to generate an idle mode cell reselection policy including a cell reselection criterion based on the received MHI, and transmit the idle mode cell reselection policy to a second UE, and using the second UE to receive the idle mode cell reselection policy, receive first and second reference signals from respective first and second cells while in an idle mode, and based on applying the idle mode cell reselection policy to the first and second reference signals, either remain in the idle mode camped on the first cell or switch out of the idle mode and perform a cell reselection so as to camp on the second cell. In some embodiments, the method includes using the network device to receive cell reselection policy performance statistics from the plurality of first UEs, modify the idle mode cell reselection policy based on the received MHI and cell reselection policy performance statistics, and transmit the modified idle mode reselection policy to the second UE. In some embodiments, using the second UE to receive the idle mode cell reselection policy includes modifying the idle mode cell reselection policy by applying a second machine learning algorithm to MHI of the second UE.

The foregoing outlines features of several embodiments so that those skilled in the art better understand the aspects of the present disclosure. Those skilled in the art appreciate that they readily use the present disclosure as a basis for designing or modifying other processes and structures for carrying out the same purposes and/or achieving the same advantages of the embodiments introduced herein. Those skilled in the art also realize that such equivalent constructions do not depart from the spirit and scope of the present disclosure, and that they make various changes, substitutions, and alterations herein without departing from the spirit and scope of the present disclosure.

What is claimed is:

1. A user equipment (UE) comprising:
a memory having non-transitory instructions stored therein; and
a processor coupled to the memory, and being configured to execute the instructions, thereby causing the UE to:
receive a cell reselection policy from a network, wherein the cell reselection policy comprises a cell reselection criterion based on mobility history information (MHI) of a plurality of UEs other than the UE;
while camped on a first cell and operating in an idle mode:
receive a first reference signal from the first cell and a second reference signal from a second cell, and
apply the cell reselection policy to the first and second reference signals, thereby determining whether to remain camped on the first cell; and
based on the determination, either remain camped on the first cell or perform a cell reselection to the second cell.

2. The UE of claim 1, wherein
the cell reselection criterion comprises a reference signal power threshold level, and
the instructions are executable by the processor to cause the UE to determine whether to remain camped on the first cell based on a comparison of the second reference signal to the reference signal power threshold level.

3. The UE of claim 1, wherein the instructions are executable by the processor to cause the UE to further apply the cell reselection policy by
using a machine learning algorithm to modify the cell reselection policy received from the network, and
using the modified cell reselection policy to determine whether to remain camped on the first cell.

4. The UE of claim 3, wherein the instructions are executable by the processor to cause the UE to modify the cell reselection policy by applying the machine learning algorithm to MHI of the UE.

5. The UE of claim 1, wherein the instructions are executable by the processor to cause the UE to determine whether to remain camped on the first cell based on the first and second reference signals being intra-frequency signals.

6. The UE of claim 1, wherein the instructions are executable by the processor to cause the UE to determine whether to remain camped on the first cell based on the first and second reference signals being inter-frequency signals.

7. The UE of claim 1, wherein the instructions are executable by the processor to further cause the UE to transmit MHI to the network, wherein the MHI comprises:
UE locations of cell reselection occurrences, discovered cell radio conditions, UE speed, and UE mode and visited cell history information, and/or
performance statistics of the cell reselection policy.

8. The UE of claim 7, wherein the instructions are executable by the processor to further cause the UE to, while remaining camped in the first cell, transmit the MHI by:
switching from operating in the idle mode to operating in a connected mode;
while operating in the connected mode, transmitting the MHI to the network; and
after transmitting the MHI, returning to operating in the idle mode.

9. The UE of claim 1, wherein the cell reselection policy is based on a capability of the UE.

10. An apparatus, comprising:
a memory having non-transitory instructions stored therein; and
a processor coupled to the memory, and being configured to execute the instructions, thereby causing the apparatus to:
receive mobility history information (MHI) from each user equipment (UE) of a plurality of first UEs;
generate a cell reselection policy comprising a cell reselection criterion based on the received MHI; and
transmit the cell reselection policy to a second UE.

11. The apparatus of claim 10, wherein the instructions are executable by the processor to cause the apparatus to generate the cell reselection policy by applying a machine learning algorithm to the received MHI.

12. The apparatus of claim 10, wherein the instructions are executable by the processor to cause the apparatus to receive the MHI comprising cell reselection policy performance statistics.

13. The apparatus of claim 12, wherein the instructions are executable by the processor to further cause the apparatus to:
modify the cell reselection policy based on the MHI comprising the cell reselection policy performance statistics, and
transmit the modified cell reselection policy to the second UE.

14. The apparatus of claim 10, wherein the instructions are executable by the processor to cause the apparatus to generate the cell reselection policy further based on a capability of the second UE.

15. The apparatus of claim 10, wherein the instructions are executable by the processor to cause the apparatus to generate the cell reselection criterion based on one or both of intra-frequency reference signals or inter-frequency reference signals.

16. The apparatus of claim 10, wherein the instructions are executable by the processor to cause the apparatus to generate the cell reselection criterion comprising a reference signal power threshold level based on the received MHI.

17. The apparatus of claim 10, wherein the apparatus comprises a radio node of a telecommunications network.

18. A method comprising:
using a network device to:
receive mobility history information (MHI) from each user equipment (UE) of a plurality of first UEs,
apply a first machine learning algorithm to the received MHI to generate an idle mode cell reselection policy comprising a cell reselection criterion based on the received MHI, and
transmit the idle mode cell reselection policy to a second UE; and
using the second UE to:
receive the idle mode cell reselection policy,
receive first and second reference signals from respective first and second cells while in an idle mode, and
based on applying the idle mode cell reselection policy to the first and second reference signals, either remain in the idle mode camped on the first cell or switch out of the idle mode and perform a cell reselection so as to camp on the second cell.

19. The method of claim 18, further comprising using the network device to:
receive cell reselection policy performance statistics from the plurality of first UEs,
modify the idle mode cell reselection policy based on the received MHI and cell reselection policy performance statistics, and
transmit the modified idle mode reselection policy to the second UE.

20. The method of claim 18, wherein the using the second UE to receive the idle mode cell reselection policy comprises modifying the idle mode cell reselection policy by applying a second machine learning algorithm to MHI of the second UE.
